(19) United States
(12) Patent Application Publication
(10) Pub. No.: US 2026/0083171 A1
(43) Pub. Date: Mar. 26, 2026

(54) ATOMIZATION CORE, ATOMIZER, AND ELECTRONIC ATOMIZATION DEVICE

(71) Applicant: SMOORE INTERNATIONAL HOLDINGS LIMITED, Grand Cayman (KY)

(72) Inventors: Jianguo WANG, Shenzhen (CN); Lingrong Xiao, Shenzhen (CN); Bo Nan, Shenzhen (CN); Junjie Tang, Shenzhen (CN); Xinqi Xia, Shenzhen (CN)

(73) Assignee: SMOORE INTERNATIONAL HOLDINGS LIMITED, Grand Cayman (KY)

(21) Appl. No.: 19/404,305

(22) Filed: Dec. 1, 2025

(30) Foreign Application Priority Data
Jun. 1, 2023 (CN) 202310646117.6

(51) Int. Cl. A24F 40/46; A24F 40/10

(52) U.S. Cl. CPC A24F 40/46; A24F 40/10

(57) ABSTRACT

An atomization core, an atomizer, and an electronic atomization device are provided. The atomization core includes a porous substrate and a heating element. The porous substrate is a porous glass-ceramic substrate. A tortuosity factor of the porous glass-ceramic substrate ranges from 1 to 2.5.

### RELATED APPLICATIONS

This application is a continuation application of International application No. PCT/CN2024/094232, filed on May 20, 2024, which claims priority to Chinese Patent Application No. 202310646117.6, filed on Jun. 1, 2023. The entire disclosure of the prior applications are hereby incorporated by reference.

### TECHNICAL FIELD

This disclosure relates to the field of electronic atomization technologies, including to an atomization core, an atomizer, and an electronic atomization device.

### BACKGROUND

An e-cigarette is a good substitute for a conventional cigarette. A common e-liquid e-cigarette is generally composed of three parts: a cigarette rod, an atomization core, and an atomization chamber. A battery is arranged in the cigarette rod, and the atomization core is set in the e-liquid chamber. The atomization core is the heart of an entire e-cigarette, e-liquid is atomized into smoke through the atomization core, and the atomized gas is discharged to a mouthpiece. Compared with the conventional cigarette, the e-cigarette has advantages of reducing harmful substances such as tar and CO in the smoke, ultimately achieving an objective of replacing smoking or alleviating addiction, and reducing absorption of the harmful substances. Currently, a manner in which a commercial electronic atomization device is atomized is mainly resistance heat-based atomization, and the e-liquid is atomized through the heating of the atomization core. Generally, the atomization core includes a porous substrate and a heating element. An existing porous substrate is usually made of a material with a porous structure, such as a cotton core and a porous ceramic, to achieve a function of guiding an atomization medium toward the heating element.

However, the ceramic material is usually manufactured by complex compositions such as diatomite, and a porous substrate manufactured by using the ceramic material has problems such as poor controllability of a pore structure and a poor e-liquid guiding effect.

### SUMMARY

An objective of this disclosure is to overcome a defect of a poor e-liquid guiding effect of pores of an atomization core of an existing porous ceramic material, so as to provide an atomization core, an atomizer, and an electronic atomization device.

To achieve the foregoing objective, this disclosure adopts the following technical solutions.

This disclosure provides an atomization core. The atomization core includes a porous substrate and a heating element. The porous substrate is a porous glass-ceramic substrate. A tortuosity factor of the porous glass-ceramic substrate ranges from 1 to 2.5.

The tortuosity factor of the porous glass-ceramic substrate ranges from 1 to 2.

The tortuosity factor of the porous glass-ceramic substrate ranges from 1.3 to 1.9.

The tortuosity factor is also referred to as aa tortuosity, and a curvature, and represents a ratio of an “effective average path length” in a porous medium to a shortest distance measured along a macroscopically seeping direction. In other words, the tortuosity factor is defined as

$$τ = \frac{{L}_{t}}{{L}_{0}} .$$

In the formula, Lₜ is a true length of a curved path, L₀ is a straight-line length (a macroscopically shortest length) of a medium, and τ is the tortuosity factor. Because a capillary tube has a complex shape, a fluid in the porous medium does not flow along a straight line, but flows forward in twists and turns. The tortuosity factor reflects a degree of such twists and turns.

A porosity of the porous glass-ceramic substrate is more than 50%.

The porosity of the porous glass-ceramic substrate ranges from 60% to 80%.

An average pore size of the porous glass-ceramic substrate ranges from 15 μm to 45 μm.

The porous glass-ceramic substrate includes pores formed by openings of glass-ceramic bubbles.

The porous glass-ceramic substrate further includes pores formed by a pore-forming agent.

The heating element is a metal heating film.

The heating element is arranged on at least one surface of the porous glass-ceramic substrate.

The metal heating film is selected from at least one of stainless steel or a nickel-containing alloy.

This disclosure provides an atomizer. The atomizer includes the foregoing atomization core.

This disclosure further provides an electronic atomization device. The electronic atomization device includes the foregoing atomizer, and further includes a battery assembly.

Beneficial effects of this disclosure are as follows.

This disclosure provides an atomization core. The atomization core includes a porous substrate and a heating element. The porous substrate is a porous glass-ceramic substrate. A tortuosity factor of the porous glass-ceramic substrate ranges from 1 to 2.5. It is found through research that the porous glass-ceramic substrate with a specific tortuosity factor helps make an entire flow time of an atomization medium shorter and an e-liquid guiding effect better under a same factor such as a capillarity force.

### BRIEF DESCRIPTION OF THE DRAWINGS

To describe technical solutions of this disclosure or in the related art more clearly, the accompanying drawings are briefly described below. Apparently, the accompanying drawings in the following description show some examples of this disclosure, and a person of ordinary skill in the art may still derive other drawings from these accompanying drawings without creative efforts.

FIG. 1 is a comparison diagram of vapor amounts of dies of atomization cores at different powers according to Example 2 and Comparative example 1 of this disclosure.

FIG. 2 is a diagram of a temperature curve of an atomization core according to Example 2 of this disclosure.

FIG. 3 is a distribution diagram of a temperature field of an atomization core according to Example 2 of this disclosure.

FIG. 4 is a diagram of deposition of soot in an atomization core after 300 puffs according to Example 2 of this disclosure.

FIG. 5 is a schematic diagram of an atomizer according to this disclosure.

FIG. 6 is a schematic diagram of an electronic atomization device according to this disclosure.

Reference numerals: 1. Atomizer; 2. Battery assembly.

### DETAILED DESCRIPTION

The following examples are provided to better understand this disclosure and are not constitute a limitation to the content and the scope of protection of this disclosure. Any product identical or similar to this disclosure obtained by anyone under the inspiration of this disclosure or by combining this disclosure with the features of other prior art shall fall within the scope of protection of this disclosure.

If no specific experimental steps or conditions are specified in the examples, the experiments can be carried out according to the conventional experimental steps or conditions described in the literature in the art. Reagents or instruments used without indicating the manufacturer are all conventional reagent products that can be purchased commercially.

An atomization manner of a commercial e-cigarette is mainly resistance heat-based atomization, and the e-liquid is atomized through the heating of the atomization core. An existing atomization core usually includes a porous substrate and a heating element. The porous substrate is usually made of a material with a porous structure, such as a cotton core and a porous ceramic, to achieve a function of guiding an atomization medium toward the heating element. However, the ceramic material is usually manufactured by complex compositions such as diatomite, and the porous substrate manufactured by using the ceramic material has poor controllability of a pore structure and a poor e-liquid guiding effect.

Therefore, this disclosure provides an atomization core. The atomization core includes a porous substrate and a heating element. The porous substrate is a porous glass-ceramic substrate. A tortuosity factor of the porous glass-ceramic substrate ranges from 1 to 2.5. The inventor found that the porous glass-ceramic substrate with a specific tortuosity factor has a relatively short through-hole path, which helps make an entire flow time of an atomization medium shorter and an e-liquid guiding effect better under a same factor such as a capillarity force. In addition, a local high temperature of an atomization surface caused by insufficient liquid supply is further avoided, a burnt flavor is avoided, and excessive soot caused by the local high temperature is also avoided, so as to improve a taste and a service life.

In some aspects, the tortuosity factor of the porous glass-ceramic substrate is 1, 1.02, 1.03, 1.04, 1.05, 1.06, 1.07, 1.08, 1.09, 1.10, 1.11, 1.12, 1.13, 1.14, 1.15, 1.16, 1.17, 1.18, 1.19, 1.20, 1.21, 1.22, 1.23, 1.24, 1.25, 1.26, 1.27, 1.28, 1.29, 1.30, 1.31, 1.32, 1.33, 1.34, 1.35, 1.37, 1.39, 1.40, 1.42, 1.45, 1.47, 1.5, 1.52, 1.53, 1.55, 1.58, 1.60, 1.63, 1.65, 1.68, 1.70, 1.72, 1.75, 1.78, 1.80, 1.84, 1.85, 1.87, 1.90, 1.94, 1.95, 1.98, 1.99, 2, 2.01, 2.02, 2.03, 2.04, 2.05, 2.06, 2.07, 2.08, 2.09, 2.10, 2.11, 2.12, 2.13, 2.14, 2.15, 2.16, 2.17, 2.18, 2.19, 2.20, 2.21, 2.22, 2.23, 2.24, 2.25, 2.26, 2.27, 2.28, 2.29, 2.30, 2.31, 2.32, 2.33, 2.34, 2.35, 2.36, 2.37, 2.38, 2.39, 2.40, 2.41, 2.42, 2.43, 2.44, 2.45, 2.46, 2.47, 2.48, 2.49, or 2.5. Further, the tortuosity factor of the porous glass-ceramic substrate ranges from 1 to 2. Still further, the tortuosity factor of the porous glass-ceramic substrate ranges from 1.3 to 1.9. During actual application of the atomization core and the atomizer, a user does not always inhale. During storage, an excessively low tortuosity factor may cause an atomization substrate of a liquid to leak out through the pores of the atomization core, causing a liquid leakage problem. Therefore, a proper tortuosity factor can consider both a liquid guiding effect and a liquid locking effect, to ensure that liquid leakage is not caused during storage, thereby improving user experience.

In some aspects, a porosity of the porous glass-ceramic substrate is more than 50%. The porosity of the porous glass-ceramic substrate ranges from 60% to 80%. The porous glass-ceramic substrate includes pores formed by openings of glass-ceramic bubbles. In some other aspects, the pores of the porous glass-ceramic substrate include pores formed by openings of glass-ceramic bubbles, and further includes pores formed by a pore-forming agent. Further, in the porous glass-ceramic substrate, a volume of the pores formed by the openings of the glass-ceramic bubbles accounts for more than 70% of a total pore volume of the porous glass-ceramic substrate. For example, a volume of the pores formed by the openings of the glass-ceramic bubbles accounts for 70.1%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, or 100% of a total pore volume of the porous glass-ceramic substrate.

The porosity (volume porosity) is defined as a proportion of the total pore volume in the porous glass-ceramic substrate to the volume of the porous glass-ceramic substrate.

In some aspects, an average pore size of the porous glass-ceramic substrate ranges from 15 μm to 45 μm. For example, the average pore size of the porous glass-ceramic substrate is 15 μm, 16μ, 17 μm, 18μ, 19 μm, 20μ, 21 μm, 22μ, 23 μm, 24μ, 25 μm, 26 μm, 27 μm, 28μ m, 29 μm, 30 μm, 31 μm, 32 μm, 33 μm, 34 μm, 35 μm, 36 μm, 37 μm, 38 μm, 39 μm, 40 μm, 41 μm, 42 μm, 43 μm, 44 μm, or 45 μm.

In some aspects, the heating element is a metal heating film. The heating element is arranged on at least one surface of the porous glass-ceramic substrate. Further, the metal heating film is selected from at least one of stainless steel or a nickel-containing alloy.

In some aspects, a manufacturing method of the heating element arranged on at least one surface of the porous glass-ceramic substrate includes at least one of printing, welding, evaporation, or deposition. For example, a heating element paste is printed on a substrate, and is formed through sintering at a preset temperature. the heating element or a heating mesh is welded to the substrate. the heating element is evaporated/deposited on the substrate through physical vapor deposition (PVD) or chemical vapor deposition (CVD).

In this disclosure, the atomization core may be obtained through a conventional method in the art, or may be obtained through sintering of the glass-ceramic bubble. The glass-ceramic bubbles have a hollow structure, which is also referred to as a hollow glass “microsphere” and may be commercially available. In some aspects, the manufacturing method of obtaining the atomization core through sintering of the glass-ceramic bubbles includes the following steps.

In some aspects, the manufacturing method of the atomization core includes the following steps.
1) Mix glass bubbles with a binder, a slipping agent, and water, and perform pressing and forming to obtain a green body.
2) Perform a first sintering, a second sintering, and a third sintering on the green body in step 1), to obtain the porous glass-ceramic substrate.
3) Manufacture a raw material of the heating element on the porous glass-ceramic substrate in step 2), and form through sintering.

In some aspects, in step (1), the binder may be an organic binder. Specifically, the binder is selected from at least one of methylcellulose, hydroxyethyl cellulose, or hydroxypropyl methylcellulose. The slipping agent may be a slipping agent of an aliphatic hydrocarbon, for example, a paraffin, or a metal stearate. Specifically, the slipping agent is sodium stearate.

In some aspects, a pressure for pressing and forming in step 1) ranges from 1 bar to 30 bar. Most of the glass bubbles do not fragment during the pressing and forming process, and a complete spherical shape of the single glass bubble is maintained. Therefore, the pressure for pressing and forming may be properly adjusted based on a compressive strength of the selected glass bubble.

In some aspects, in step 2), a first temperature of the first sintering is at least 200° C., for example, 300° C. to 400° C., and/or a first residence time is at least 1 minute, for example, 1 hour to 10 hours. During the sintering process at the temperature, a substance such as a solvent and a binder is removed from the green body.

In some aspects, a second temperature of the second sintering is greater than 400° C. and less than a softening point of glass of the glass bubble. for example, 500° C., 600° C., or 700° C., and a second residence time thereof is at least 1 minute, for example, 1 hour to 10 hours. The purpose of the second temperature is greater than 400° C. and less than the softening point of the glass of the glass bubbles is to keep an original form of the green body unchanged. In addition, because the temperature has already exceeded 400° C., a glass composition in the glass bubbles starts to change. A disordered glass phase partially crystallizes to a crystal phase within the temperature range, and the glass bubbles are converted into the glass-ceramic bubbles. In addition, due to the conversion, some of the glass bubbles begin to crack and have at least one opening. Therefore, the sintering time within the temperature range may be properly adjusted to regulate the crystallinity of the porous glass-ceramic. It may be understood that the glass bubbles of the raw material may also include a certain proportion of the crystal phase, which may shorten the sintering time in this process.

In some aspects, a third temperature of the third sintering is greater than the softening point of the glass. Specifically, a temperature of the softening point of the glass is less than 900° C. A third residence time may be at least 1 minute, for example, 1 hour to 10 hours. At this temperature, the glass composition has flowability. Therefore, adjacent glass-ceramic bubbles are directly adhered to each other. In addition, because the glass-ceramic bubbles still have a crystal phase composition, the crystal phase composition, as a framework, causes the form of the glass-ceramic bubbles to not collapse, and still maintains a basic complete form. In addition, the glass-ceramic bubbles are further cracked to form a large quantity of openings. The openings are in communication with each other to form pores. The pores extend through the porous glass-ceramic substrate and reach a surface of the porous glass-ceramic substrate.

The third temperature is greater than the softening point of the glass of the glass bubble. The glass-ceramic bubbles are heated at least to a softening temperature of an amorphous glass, so that most of the glass-ceramic bubbles open due to expansion of air in the bubble. In addition, the heating causes the adjacent glass-ceramic bubbles to sinter together and form a bond. Overall, the bonded open glass-ceramic bubbles form the pores of the porous glass-ceramic substrate. The glass-ceramic bubbles are applied to an atomizer and an electronic atomization device, so as to effectively improve atomization efficiency and a liquid guiding effect.

In some aspects, a mass ratio of the glass bubbles to the binder, the slipping agent, and the water is (80-140):(10-40):(2.5-3.6):(50-85).

In some aspects, in step 3), the raw material of the heating element may be at least one of the electronic paste (metal paste), the heating wire, or the heating mesh. The electronic paste may be directly applied to the surface of the porous glass-ceramic substrate through screen printing based on a preset contour, and then is formed through sintering at the preset temperature. The sintering temperature may be adaptively adjusted based on types of a bonding phase and a metal composition in the electronic paste. Generally, the sintering temperature ranges from 400° C. to 800° C.

In some aspects, the glass composition of the glass bubbles may be soda-lime silicate glass, borosilicate glass, or another glass. Specifically, the glass composition may include: 74-85% of SiO₂, 6.5-10% of CaO, 5-9% of B₂O₃, 0.4-2% of Al₂O₃, 0.01-1% of Fe₂O₃, 1-3% of Na₂O, and 0.1-0.5% of K₂O.

In an example, in step 1), the pore-forming agent is further added. the pore-forming agent is selected from at least one of starch, polymethyl methacrylate (PMMA), polystyrene (PS), or graphite. a particle size of the pore-forming agent may range from 1 μm to 150 μm. It may be understood that the addition of the pore-forming agent may further increase the porosity of the porous glass-ceramic substrate in a case that the strength of the glass bubbles of the raw material is ensured.

In some aspects, in step 1), a second inorganic material is further included. The second inorganic material may be at least one of clay, talc, silica, or alumina. Melting points or softening points of the foregoing materials are greater than the softening point of the glass in the glass bubble.

In some aspects, a mass ratio of the glass bubbles to the binder, the slipping agent, the water, the pore-forming agent, and the second inorganic material is (80-140):(10-40):(2.5-3.6):(50-85):(0-45):(0-7).

As shown in FIG. 5, this disclosure further provides an atomizer. The atomizer includes the foregoing atomization core. The atomizer includes a shell. A liquid storage tank and an atomization cavity are formed in the shell. The liquid storage tank is configured to store a liquid atomization medium, and the atomization cavity is configured to accommodate the foregoing atomization core. The atomization core may atomize the liquid atomization medium.

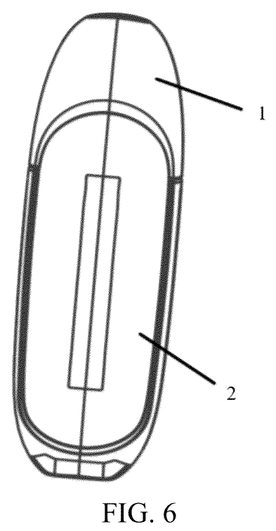

As shown in FIG. 6, this disclosure further provides an electronic atomization device. The electronic atomization device includes the foregoing atomizer 1, and further includes a battery assembly 2. The battery assembly and the atomizer may be of an integrated structure or a detachable structure. The battery assembly is configured to supply power to the atomizer based on a preset mode, so that the atomizer atomizes the liquid atomization medium based on the preset mode.

This disclosure is further described in detail below with reference to examples. These examples cannot be understood as limiting the protection scope of this disclosure.

In this disclosure, the composition of the glass bubbles is soda-lime silicate glass. The glass bubbles of the raw material with a same composition are used in the following examples, where D10=18.61 μm, D50=39.38 μm, and D90-69.47 μm, and the porosity in the single glass bubble is 84.8%. Main compositions of the glass bubbles of the raw material are: Si: 41.647 wt %, O: 49.375 wt %, Na: 3.778 wt %, Ca: 4.619 wt %, Mg: 0.201 wt %, and Al: 0.379 wt %.

### Example 1

This example provides an atomization core. A manufacturing method thereof includes the following steps.
1) Mix 80 g of glass bubbles with 30 g of hydroxyethyl cellulose, 2.5 g of sodium stearate, and 80 g of water, and perform pressing and forming to obtain a green body, where a forming pressure is 7 bar.
2) Perform a first sintering, a second sintering, and a third sintering on the green body in step 1), to obtain a porous glass-ceramic substrate, where a first sintering temperature is 310° C., a first sintering time is 3 h, a second sintering temperature is 540° C., a second sintering time is 3 h, a third sintering temperature is 1000° C., and a third sintering time is 4 h.
3) Print a 310 stainless steel paste on the porous glass-ceramic substrate in step 2) and form through sintering, a sintering temperature being 700° C. and a sintering time being 3 h, to obtain the atomization core.

### Example 2

This example provides an atomization core. A manufacturing method thereof includes the following steps.
1) Mix 140 g of glass bubbles with 35.02 g of hydroxyethyl cellulose, 3.52 g of sodium stearate, 2.78 g of clay, and 80.04 g of water, and perform pressing and forming to obtain a green body, where a forming pressure is 24 bar.
2) Perform a first sintering, a second sintering, and a third sintering on the green body in step 1), to obtain a porous glass-ceramic substrate, where a first sintering temperature is 350° C., a first sintering time is 2.5 h, a second sintering temperature is 690° C., a second sintering time is 3 h, a third sintering temperature is 1500° C., and a third sintering time is 3.5 h.
3) Print a 310 stainless steel paste on the porous glass-ceramic substrate in step 2) and form through sintering, a sintering temperature being 800° C. and a sintering time being 5 h, to obtain the atomization core.

### Example 3

This example provides an atomization core. A manufacturing method thereof includes the following steps.
1) Mix 135 g of glass bubbles with 40 g of hydroxyethyl cellulose, 3 g of sodium stearate, 7 g of clay, and 85 g of water, and perform pressing and forming to obtain a green body, where a forming pressure is 15 bar.
Step 2) and Step 3) are the same as those in Example 1, to obtain the atomization core.

### Comparative Example 1

This comparative example provides an atomization core, as recorded in the patent CN114668183A. Specifically, a porous body of the atomization core includes a large-size structural layer and a small-size structural layer that are superposed. An average pore size of the large-size structure layer ranges from 50 μm to 150 μm, and an average pore size of the small-size structure layer ranges from 20 μm to 100 μm. An average porosity of the porous body ranges from 50% to 75%.

### Comparative Example 2

This comparative example provides an atomization core. A manufacturing method thereof includes the following steps.
1) Mix 80 g of glass powder with 30 g of hydroxyethyl cellulose, 2.5 g of sodium stearate, 80 g of a pore-forming agent, and 160 g of water, and perform pressing and forming to obtain a green body, where the molding pressure is 20 bar and the pore-forming agent is polymethyl methacrylate (PMMA).

Step 2) and Step 3) are the same as those in Example 1, to obtain the atomization core.

### Test Example 1

Testing for a tortuosity factor, an average e-liquid guiding time, a porosity, and an average pore size is performed the porous substrates in the atomization cores in the examples and the comparative examples of this disclosure. A test method for the average e-liquid guiding time is as follows. The porous substrate of the atomization core is placed in an oven at 120° C. for 15 min, and then is placed in a drying vessel for natural cooling (approximately 15 min). 0.70±0.01 g of e-liquid is placed in exclusive e-liquid guide metalware, and the porous substrate is placed in the metalware, and a time required for completely immersing the porous substrate with the e-liquid is recorded through a stop watch. The test method for the porosity, the average pore size, and the tortuosity factor is a mercury intrusion method (the test device is a mercury porosimeter).

An inhalation experiment is performed through the atomization core in the example, to respectively test for soot, a lifespan, and an inhalation taste of the electronic atomization device. After a preset quantity of puffs (the preset quantity of puffs is 500), the soot on the surface of the atomization core is observed, to determine a deposit condition of the soot. During a process of inhaling the preset quantity of puffs, whether a failure situation exists is tested, and statistics collection is performed to record a lifespan situation thereof. The failure situation mainly includes: 1. A significant abnormal change of a resistance of the atomization core
(for example, a significant increase in the resistance caused by splitting or shedding of the heating element). 2. A fog output volume is less than half of an initial atomization amount. The inhalation taste is determining, by a tester, whether any abnormal taste such as a burnt flavor exists during a preset process of inhaling 500 puffs. The foregoing test condition are 6.5 W power and a die (not assembled as an atomizer). When the taste is tested, the atomization core is assembled as an atomizer for testing.

TABLE 1

| | | | Average | Average e- | | | |
|---|---|---|---|---|---|---|---|
| | Tortuosity | Porosity | pore size | liquid guiding | | | Lifespan |
| | factor | (%) | (μm) | time (s) | Soot | Taste | (500 puffs) |
| Example 1 | 1.58 | 71.87 | 23.82 | 48.70 | Less | No burnt | No failure |
| | | | | | soot | flavor | |
| Example 2 | 1.75 | 70.99 | 17.56 | 99.46 | Less | No burnt | No failure |
| | | | | | soot | flavor | |
| Example 3 | 1.41 | 81.49 | 22.55 | 35.57 | Less | No burnt | No failure |
| | | | | | soot | flavor | |
| Comparative | — | 50-75 | 20-100/ | — | — | — | — |
| example 1 | | | 50-150 | | | | |
| Comparative | 3.5 | 65 | 20.5 | — | More | No burnt | Failure after |
| example 2 | | | | | soot | flavor | 380 puffs |

### Test Example 2

The core dies of the atomization cores in Example 2 and Comparative example 1 are tested for vapor amounts under different powers, and the e-liquid used are strawberry watermelon e-liquid and Laike watermelon e-liquid. A specific test method is as follows. An inhalation experiment is performed on the atomization core. Each inhalation process (namely, each puff) includes: inhaling for 3 s and then pausing for 8 s, testing the vapor amount in each inhalation process, and performing statistics collection to obtain an average value.

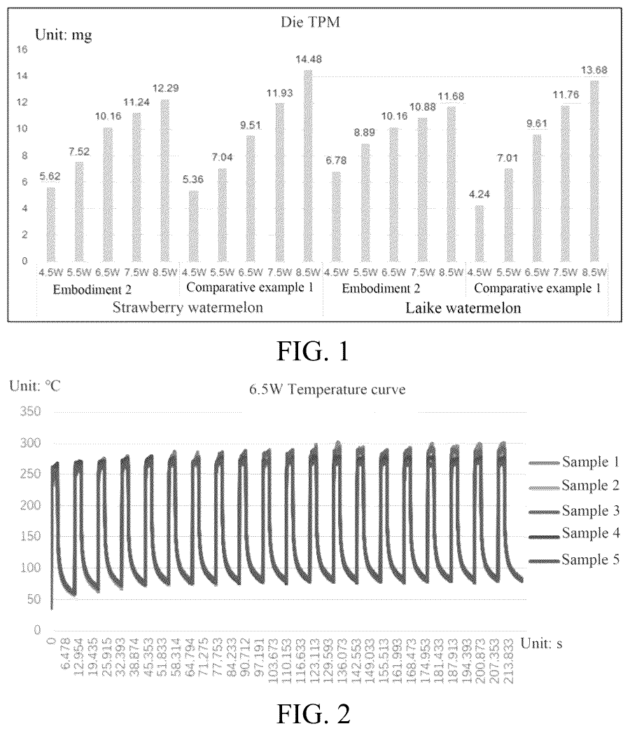

The test result is as shown in FIG. 1. When a power range of the atomization core ranges from 4.5 W to 6.5 W in Example 2, the vapor amount linearly increases, and tends to slow down at 6.5 W. Therefore, the atomization core has high atomization efficiency. When the Laike watermelon e-liquid is used for testing, the atomization efficiency at 4.5 W is 1.51 mg/W, the atomization efficiency at 5.5 W is 1.62 mg/W, and the atomization efficiency at 6.5 W is 1.56 mg/W.

For the atomization core in Comparative example 1: in a range of 4.5 W to 8.5 W, the vapor amount linearly increases. In a range of 4.5 W to 6.5 W, the vapor amount is lower than that of the atomization core in this example.

The inventor considered through analysis that a smaller tortuosity factor indicates a shorter relative distance for e-liquid to pass through the atomization core, which makes an entire flow time of an atomization medium shorter, a vapor amount larger, and an e-liquid guiding effect better under a same factor such as a capillarity force. In a case of a relatively low power, for example, 4.5 W to 6.5 W, the atomization core of this disclosure provides sufficient liquid supply and has high atomization efficiency. However, in a case of a relatively high power, a large-size atomization core is more advantageous, but the large-size atomization core causes a problem of liquid leakage. Therefore, the atomization core of this disclosure has a liquid guiding rate, atomization efficiency, and a liquid locking effect.

### Test Example 3

A temperature field distribution test is performed on the atomization core in Example 2, and the tested e-liquid is fruit (watermelon) taste e-liquid. The test method is as follows. The atomization core is assembled with an atomizer and an electronic atomization device for an inhalation experiment. Each inhalation process (namely each puff) includes 3 s of inhalation and 8 s of pause. A distribution of the temperature field is obtained by using an infrared thermometer for the temperature field of the atomization core, and then statistics collection is performed on the distribution of the temperature field. In total, 5 parallel samples are tested, and are respectively denoted as Sample 1 to Sample 5.

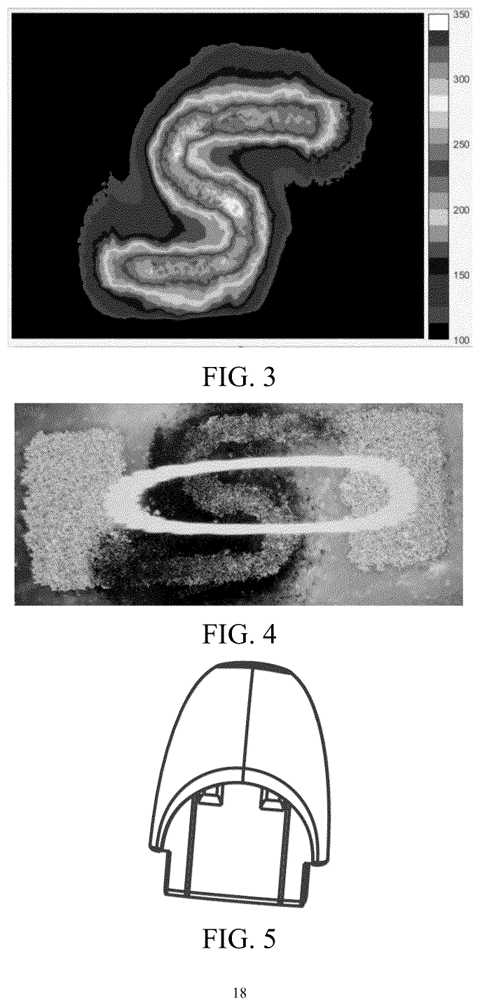

For the test result, reference is further made to FIG. 2 and FIG. 3. The abscissa in FIG. 2 represents a time, and the unit is second(s). In other words, a total quantity of puffs is 20. The ordinate in FIG. 2 represents a temperature, and the unit is degrees centigrade (° C.). As shown in FIG. 2, during each inhalation process (each puff), a temperature of the main atomization zone ranges from 250° C. to 300° C. FIG. 3 is a temperature field distribution diagram in one puff on one sample (Sample 1), where no individual high-temperature zone (a zone exceeding 310° C.) occurs. It can be learned that the entire liquid supply of the atomization core is sufficient, and the liquid guiding effect of the porous substrate is desirable. FIG. 4 shows deposition of soot on a surface of an atomization surface after 300 puffs on a sample. Although a small amount of soot exists, the soot is relatively evenly distributed in an entire zone of the atomization surface, and does not aggregate on the surface of the heating element. Therefore, the entire service life is facilitated to improve.

Therefore, the inventor considered through analysis that the temperature field is concentrated at a high efficiency zone and has a certain temperature field gradient. Therefore, the atomization core has high atomization efficiency, is not easy to scale, and has rich taste layers.

Obviously, the above examples are merely examples for clear description and not limitations on the aspects. For a person of ordinary skill in the art, other changes or alterations in different forms may also be made based on the foregoing description. All aspects are not required and cannot be exhaustive herein. The obvious changes or modifications derived therefrom are still within the protection scope of this disclosure.

What is claimed is:

1. An atomization core comprising:
a heating element; and
a porous glass-ceramic substrate, a tortuosity factor of the porous glass-ceramic substrate ranges from 1 to 2.5.

2. The atomization core of claim 1, wherein the tortuosity factor of the porous glass-ceramic substrate ranges from 1 to 2.

3. The atomization core of claim 2, wherein the tortuosity factor of the porous glass-ceramic substrate ranges from 1.3 to 1.9.

4. The atomization core of claim 1, wherein a porosity of the porous glass-ceramic substrate is more than 50%.

5. The atomization core of claim 4, wherein the porosity of the porous glass-ceramic substrate ranges from 60% to 80%.

6. The atomization core of claim 1, wherein an average pore size of the porous glass-ceramic substrate ranges from 15 μm to 45 μm.

7. The atomization core of claim 6, wherein the average pore size of the porous glass-ceramic substrate ranges from 17 μm to 24 μm.

8. The atomization core of claim 1, wherein the porous glass-ceramic substrate comprises pores formed by openings of glass-ceramic bubbles.

9. The atomization core of claim 1, wherein the heating element is a metal heating film; and
the heating element is arranged on at least one surface of the porous glass-ceramic substrate.

10. The atomization core of claim 9, wherein the metal heating film is stainless steel and/or a nickel-containing alloy.

11. An atomizer comprising:
a liquid storage being configured to store a liquid atomization medium; and
an atomization core atomizing the liquid atomization medium, the atomization core comprising:
a heating element; and
a porous glass-ceramic substrate, a tortuosity factor of the porous glass-ceramic substrate ranges from 1 to 2.5.

12. An electronic atomization device comprising:
a battery assembly;
a liquid storage being configured to store a liquid atomization medium; and
the battery assembly supplying power to an atomization core to atomize the liquid atomization medium, the atomization core comprising:
a heating element; and
a porous glass-ceramic substrate, a tortuosity factor of the porous glass-ceramic substrate ranges from 1 to 2.5.
